(19) United States
(12) Patent Application Publication
(10) Pub. No.: US 2025/0007197 A1
(43) Pub. Date: Jan. 2, 2025

(54) CONNECTOR

(71) Applicant: SUMITOMO WIRING SYSTEMS, LTD., Mie (JP)

(72) Inventors: Hiroto SAKAI, Mie (JP); Ryota YONEMITSU, Mie (JP)

(21) Appl. No.: 18/757,661

(22) Filed: Jun. 28, 2024

(30) Foreign Application Priority Data
Jun. 28, 2023 (JP) 2023-105783

(51) Int. Cl. H01R 13/422

(52) U.S. Cl. CPC H01R 13/422

(57) ABSTRACT

A terminal fitting includes a pair of first surfaces that face toward opposite sides in the vertical direction, a pair of second surfaces that face toward opposite sides in the left-right direction, and a pair of stoppers that protrude in the left-right direction relative to the second surfaces. The press-fitting hole includes a pair of first opposed surfaces that are opposed to the first surfaces, a pair of second opposed surfaces that are opposed to the second surfaces, and contact surfaces with which the stoppers are capable of coming into contact in the forward direction. The pair of first opposed surfaces each include a first guiding surface, the pair of first guiding surfaces being inclined to increase a distance therebetween from inclination front end positions to inclination back end positions. The inclination front end positions are located forward of the contact surfaces.

### CROSS-REFERENCE TO RELATED APPLICATIONS

This application is based on and claims priority from Japanese Patent Application No. 2023-105783, filed on Jun. 28, 2023, with the Japan Patent Office, the disclosure of which is incorporated herein in its entirety by reference.

### TECHNICAL FIELD

The present disclosure relates to a connector.

### BACKGROUND

JP 2003-059568 A, JP 2009-117064 A, and JP 2021-072149 A disclose a configuration in which a terminal fitting is press-fitted into an installation hole formed in a housing made of a synthetic resin.

### SUMMARY

When such a configuration is employed, glass fibers may be added to the resin material for the housing in order to increase the strength of the housing. In this case, the ends of the added glass fibers may be exposed inside the installation hole. In such a case, when the terminal fitting is press-fitted into the installation hole, a plating layer or the like formed on the outer surface of the terminal fitting may be abraded due to the exposed ends of the glass fibers.

Therefore, it is an object of the present disclosure to provide a connector capable of preventing the occurrence of trouble caused by the abrasion of the outer surface of the terminal fitting, or the like when press-fitting the terminal fitting into the housing.

A connector of the present disclosure includes: a housing provided with a press-fitting hole; and a terminal fitting that is press-fitted into the press-fitting hole from a back side in a press-fitting direction and is held in the housing, wherein the terminal fitting includes a pair of first surfaces that face toward opposite sides in a first direction intersecting the press-fitting direction, a pair of second surfaces that face toward opposite sides in a second direction intersecting the press-fitting direction and the first direction, and a pair of stoppers that protrude in the left-right direction (second direction) relative to the second surfaces, the press-fitting hole includes a pair of first opposed surfaces that are opposed to the first surfaces, a pair of second opposed surfaces that are opposed to the second surfaces, and contact surfaces with which the stoppers are capable of coming into contact in the press-fitting direction, the pair of first opposed surfaces each include a first guiding surface, the pair of first guiding surfaces being inclined to increase a distance therebetween from inclination front end positions to inclination back end positions, and the inclination front end positions are located forward of the contact surfaces in the press-fitting direction.

With the present disclosure, it is possible to prevent the occurrence of trouble caused by the abrasion of the outer surface of the terminal fitting when press-fitting the terminal fitting into the housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector of an embodiment.

FIG. 2 is a back view of the connector attached to a circuit board.

FIG. 3 is an enlarged back view showing a press-fitting hole.

FIG. 4 is an end view taken along line A-A in FIG. 2.

FIG. 5 is an end view taken along line B-B in FIG. 2.

FIG. 6 is a perspective view showing a terminal fitting.

FIG. 7 is a front view showing the terminal fitting.

FIG. 8 is an end view that corresponds to FIG. 4 and shows a state in which the terminal fitting is press-fitted into the press-fitting hole.

FIG. 9 is an end view that corresponds to FIG. 5 and shows a state in which the terminal fitting is press-fitted into the press-fitting hole.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.

(1) A connector including: a housing provided with a press-fitting hole; and a terminal fitting that is press-fitted into the press-fitting hole from a back side in a press-fitting direction and is held in the housing, wherein the terminal fitting includes a pair of first surfaces that face toward opposite sides in a first direction intersecting the press-fitting direction, a pair of second surfaces that face toward opposite sides in a second direction intersecting the press-fitting direction and the first direction, and a pair of stoppers that protrude in the left-right direction (second direction) relative to the second surfaces, the press-fitting hole includes a pair of first opposed surfaces that are opposed to the first surfaces, a pair of second opposed surfaces that are opposed to the second surfaces, and contact surfaces with which the stoppers are capable of coming into contact in the press-fitting direction, the pair of first opposed surfaces each include a first guiding surface, the pair of first guiding surfaces being inclined to increase a distance therebetween from inclination front end positions to inclination back end positions, and the inclination front end positions are located forward of the contact surfaces in the press-fitting direction.

In the connector of the aspect (1), the inclination front end positions are located forward of the contact surfaces in the press-fitting direction. This enables a reduction of the area of contact between the first surface and the first opposed surface, thus making it less likely that the first surfaces of the terminal fitting are abraded by the first opposed surfaces. In addition, when the terminal fitting is press-fitted into the press-fitting hole, abrasion powder resulting from the abrasion of the plating layer or the like that forms the first surface by the first opposed surface is likely to be held between the first guiding surface and the first surface. This makes it likely to prevent trouble caused by the abrasion powder from the terminal fitting.

(2) The connector according to the aspect (1), wherein the terminal fitting includes a pair of locking portions that protrude in the second direction relative to the second surfaces and are located forward of the stoppers in the press-fitting direction, and in a state in which the stoppers are in contact with the contact surfaces, apexes of the locking portions are located at the same position as those of the inclination front end positions in the press-fitting direction or are located forward of the inclination front end positions in the press-fitting direction.

In the connector of the aspect (2), the locking portions are press-fitted into the press-fitting hole after the positions of the locking portions in the first direction are determined, thus making it easy to suppress the positional shift of the locking portions in the first direction.

(3) The connector according to the aspect (1) or (2), wherein the housing includes a press-fitting surface in which the press-fitting hole is open, the contact surfaces being located forward of the press-fitting surface in the press-fitting direction, and the first guiding surfaces intersect and are continuous with the press-fitting surface.

In the connector of the aspect (3), the function of the first guiding surfaces to guide the terminal fitting to the press-fitting hole is exhibited over a broad range in the press-fitting direction. In addition, for example, it is easy to secure the clearance between a jig for pressing the terminal fitting and the opening.

(4) The connector according to the aspect (2), wherein second guiding surfaces are each formed between the second opposed surface and the contact surface, the second guiding surfaces forming a tapered shape and being capable of coming into contact with the locking portions when the terminal fitting is press-fitted into the press-fitting hole.

In the connector of the aspect (4), the second guiding surfaces can guide the locking portions, thus making it easy to press-fit the terminal fitting into the press-fitting hole.

(5) The connector according to the aspect (1) or (2), a dimension between the pair of first surfaces is smaller than a dimension between the pair of first opposed surfaces.

In the connector of the aspect (5), when the terminal fitting is press-fitted into the press-fitting hole, it is possible to make it unlikely that the first surfaces come into contact with the first opposed surfaces, thus making it less likely that the terminal fitting is abraded.

(6) The connector according to the aspect (5), wherein dimensions of the first surfaces in the second direction are larger than dimensions of the second surfaces in the first direction.

In the connector of the aspect (6), the dimensions of the first opposed surfaces (first guiding surfaces) in the second direction are increased, thus making it likely to reduce the contact pressure per unit area when the first guiding surfaces and the first surfaces come into contact with each other and to improve the effect of preventing the abrasion of the first surfaces.

### DETAILS OF EMBODIMENTS OF THE PRESENT DISCLOSURE

### Embodiment 1

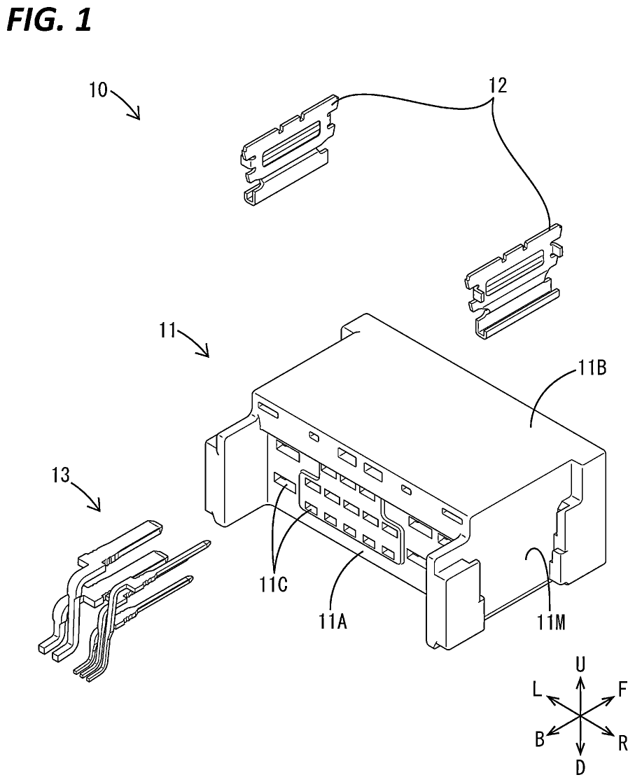

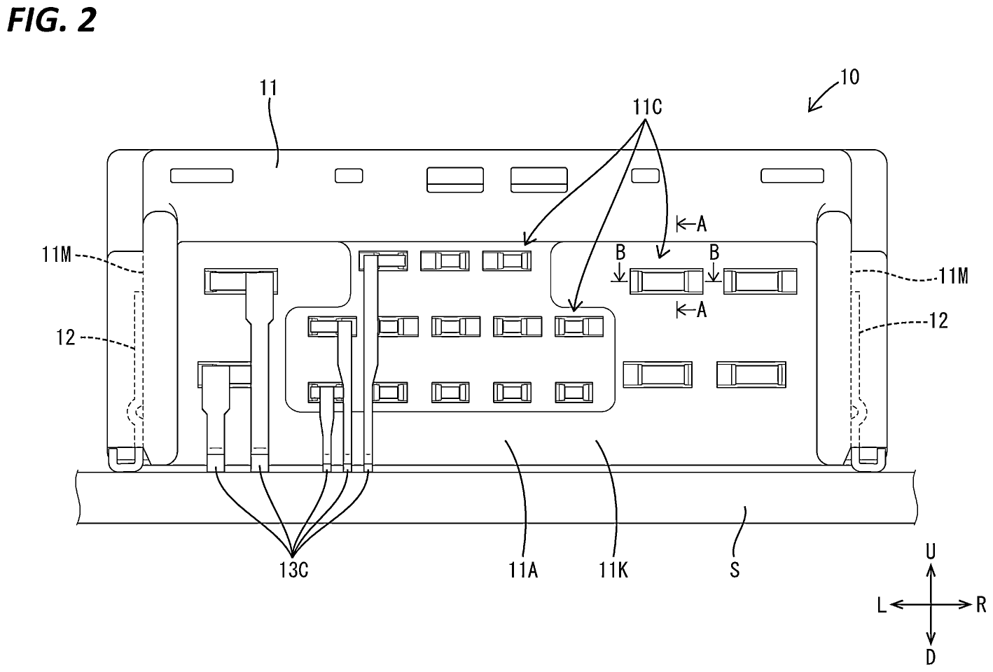

The following describes Embodiment 1 in which a connector 10 of the present disclosure is embodied, with reference to FIGS. 1 to 9. In the diagrams, the “front side”, the “back side”, the “upside”, the “downside”, the “right side”, and the “left side” are represented by “F”, “B”, “U”, “D”, “R”, and “L”, respectively. The press-fitting direction is parallel to the front-back direction and is included in the concept of the front-back direction. Here, the press-fitting direction is a direction in which a terminal fitting 13 is moved when the terminal fitting 13 is press-fitted into a housing 11, and is a forward direction in the front-back direction. The left-right direction corresponds to a second direction, and the vertical direction corresponds to a first direction. The left-right direction and the width direction are used interchangeably. The connector 10 is, for example, to be attached to a circuit board S (see FIG. 2). As shown in FIG. 1, the connector 10 includes a housing 11, a pair of pegs 12, and a plurality of terminal fittings 13.

### [Configuration of Housing]

The housing 11 is made of, for example, a synthetic resin to which glass fibers are added. The housing 11 includes a press-fitting wall portion 11A and a hood portion 11B that protrudes forward from the outer peripheral portion of the press-fitting wall portion 11A. The press-fitting wall portion 11A has a flat plate shape, and the thickness direction thereof extends in the front-back direction. The hood portion 11B can be fitted to a partner housing (not illustrated).

As shown in FIG. 2, the press-fitting wall portion 11A is provided with a plurality of press-fitting holes 11C. The press-fitting holes 11C pass through the press-fitting wall portion 11A in the front-back direction. The press-fitting holes 11C are open in a press-fitting surface 11K, which is the back surface of the press-fitting wall portion 11A. The press-fitting holes 11C are arranged to form a plurality of rows in the vertical direction and a plurality of columns in the left-right direction. [Configuration of Press-Fitting Hole]

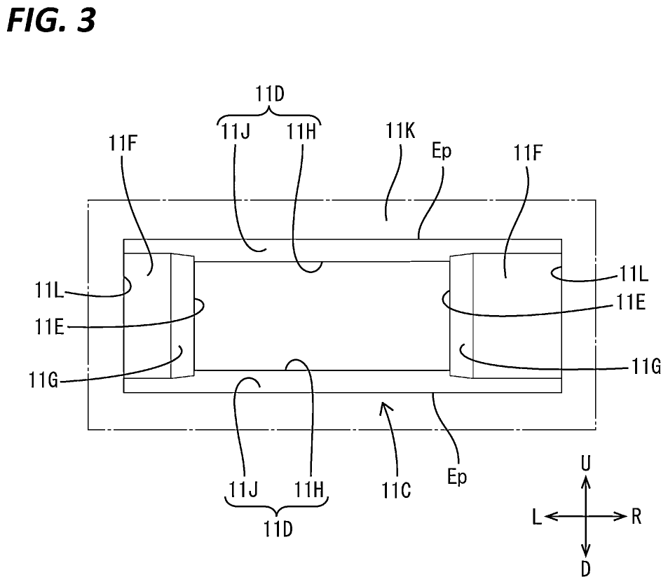

Next, the configuration of the press-fitting hole 11C will be described. The plurality of press-fitting holes 11C formed in the housing 11 vary in size and dimensions of portions, but all of them have a configuration described below. As shown in FIGS. 3 to 5, each of the press-fitting holes 11C has a pair of first opposed surfaces 11D, a pair of second opposed surfaces 11E, a pair of second guiding surfaces 11G, and a pair of contact surfaces 11F.

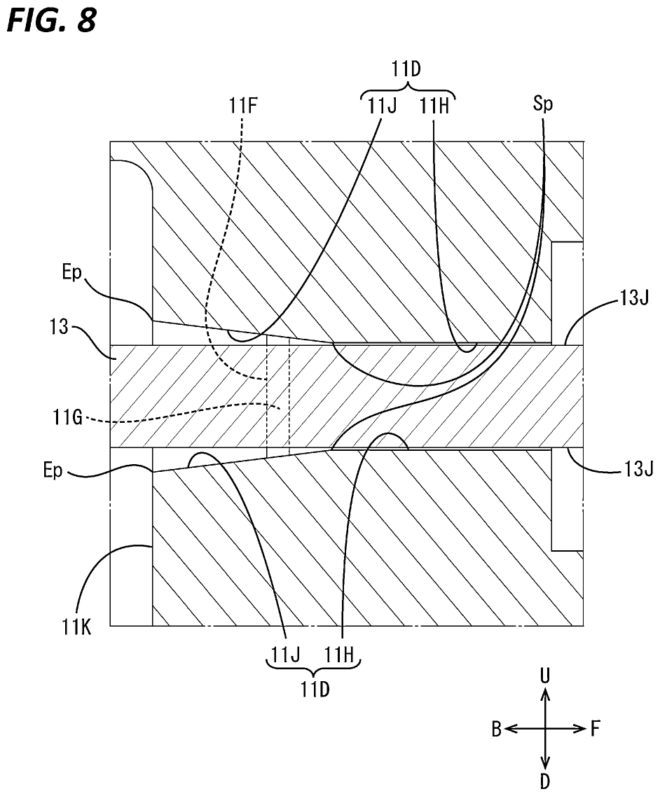

The pair of first opposed surfaces 11D correspond to the upper and lower surfaces of the inner surfaces of the press-fitting hole 11C. In the state in which the terminal fitting 13, which will be described later, is press-fitted into the press-fitting hole 11C, each of the first opposed surfaces ID is opposed to a first surface 13J of the terminal fitting 13 (see FIG. 8). The first opposed surface 11D extends in the front-back direction and the left-right direction. The first opposed surface 11D includes a parallel surface 11H and a first guiding surface 11J. A pair of parallel surfaces 11H correspond to the front regions of the first opposed surfaces 11D. The pair of parallel surfaces 11H are parallel to each other and are opposed to each other in the vertical direction.

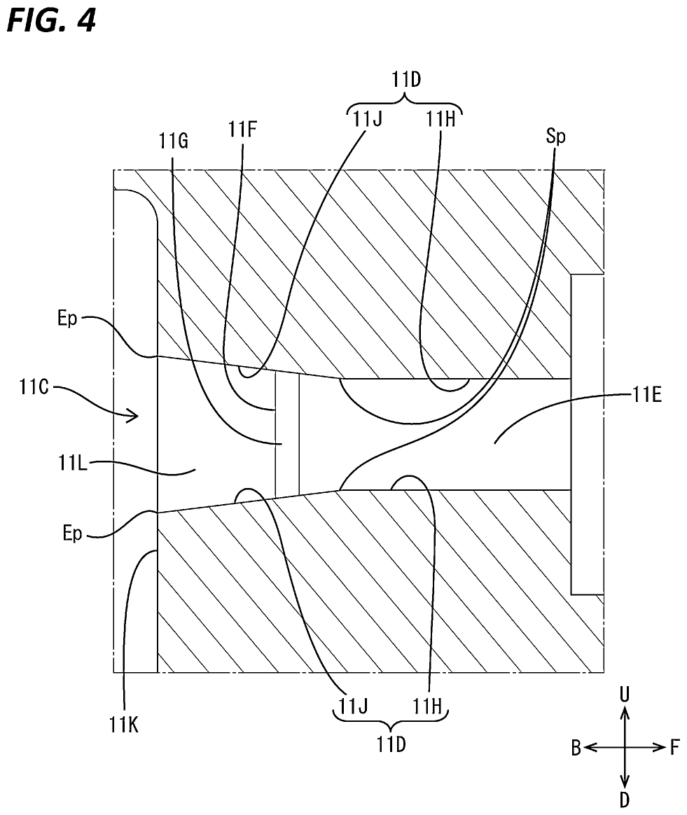

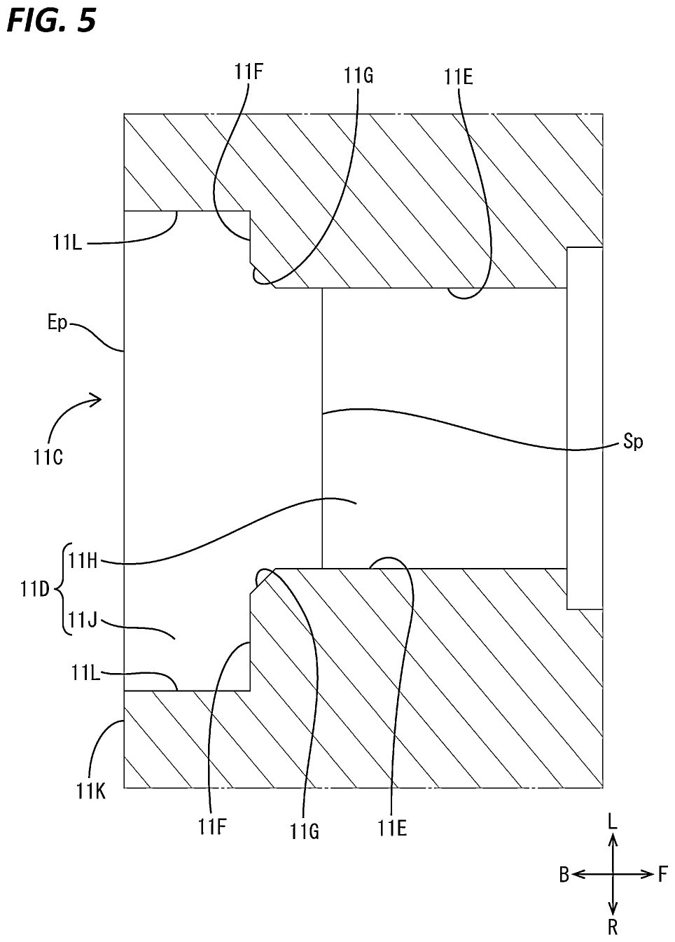

The first guiding surfaces 11J have a planar shape. The first guiding surfaces 11J are continuous with the back ends of the parallel surfaces 11H and extend backward. The pair of first guiding surfaces 11J are inclined such that the distance therebetween increases in the vertical direction toward the back ends thereof. The position of the boundary at which the first guiding surface 11J and the parallel surface 11H are continuous with each other is an inclination front end position Sp (see FIG. 4). The inclination front end position Sp is located forward of the contact surface 11F (on the front side in the press-fitting direction) (See FIGS. 4 and 5). Each of the first guiding surfaces 11J intersects the press-fitting surface 11K and is continuous therewith. The position at which the first guiding surface 11J and the press-fitting surface 11K are continuous with each other is an inclination back end position Ep (see FIGS. 3 and 4). The pair of first guiding surfaces 11J are inclined such that the distance therebetween increases from the inclination front end positions Sp to the inclination back end positions Ep (see FIG. 4).

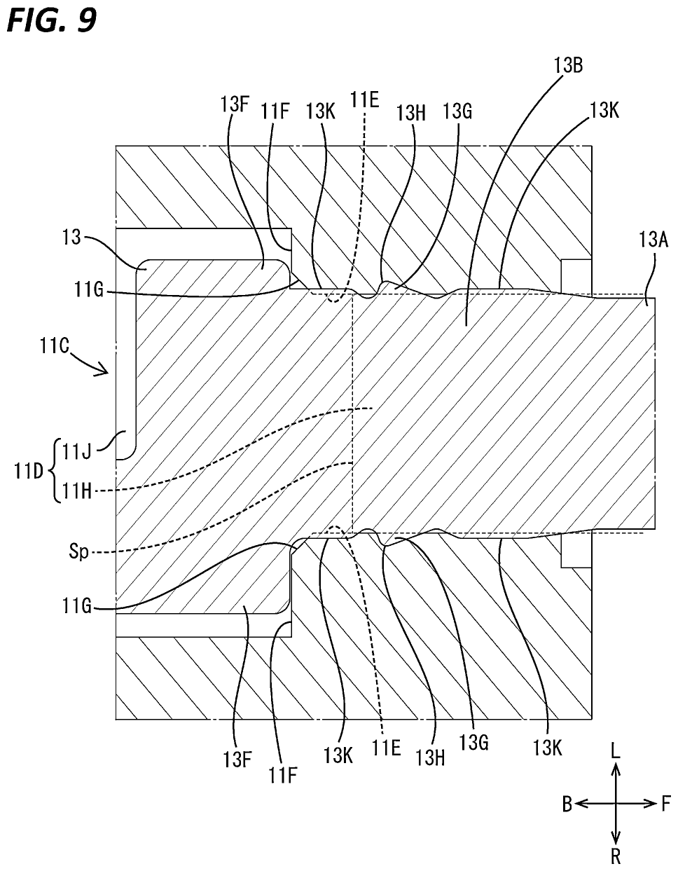

The pair of second opposed surfaces 11E correspond to the left and right surfaces of the inner surfaces of the press-fitting hole 11C. In the state in which the terminal fitting 13, which will be described later, is press-fitted into the press-fitting hole 11C, each of the second opposed surfaces 11E is opposed to a second surface 13K of the terminal fitting 13 (see FIG. 9). The second opposed surface 11E extends in the front-back direction and the vertical direction. The pair of second opposed surfaces 11E are parallel to each other and are opposed to each other in the left-right direction. The second opposed surface 11E is perpendicular to the parallel surface 11H of the first opposed surface 11D.

The pair of second guiding surfaces 11G are continuous with the back ends of the second opposed surfaces 11E (see FIGS. 4 and 5). The second guiding surfaces 11G are inclined to form a tapered shape extending outward in the left-right direction and backward (see FIG. 5).

As shown in FIG. 5, the pair of contact surfaces 11F are continuous with the back ends of the pair of second guiding surfaces 11G. Stoppers 13F, which will be described later, are capable of coming into contact with the contact surfaces 11F in the forward direction (press-fitting direction). In other words, each of the second guiding surfaces 11G is formed between the second opposed surface 11E and the contact surface 11F. Each of the contact surfaces 11F extends in the left-right direction and the vertical direction, and extends outward in the left-right direction from the back end of the second guiding surface 11G. The contact surface 11F is perpendicular to the second opposed surface 11E. Third opposed surfaces 11L that extend backward are continuous with the outer edges in the left-right direction of the contact surfaces 11F. The third opposed surfaces 11L are parallel to the second opposed surfaces 11E, and the back ends thereof are continuous with the press-fitting surface 11K. The width in the left-right direction between the pair of second opposed surfaces 11E is smaller than the width in the left-right direction between the pair of third opposed surfaces 11L. The contact surfaces 11F are located forward of the press-fitting surface 11K (on the front side in the press-fitting direction).

Left and right side wall portions of the hood portion 11B are each provided with a recess 11M that is recessed inward in the left-right direction (or that is a step-shaped portion located inward from the outermost shape in the left-right direction) (see FIG. 1).

### [Configuration of Peg]

The pegs 12 are made of a metal and have a flat plate shape as a whole. The pegs 12 are inserted into the recesses 11M of the left and right side wall portions of the housing 11 (see FIGS. 1 and 2).

### [Configuration of Terminal Fitting]

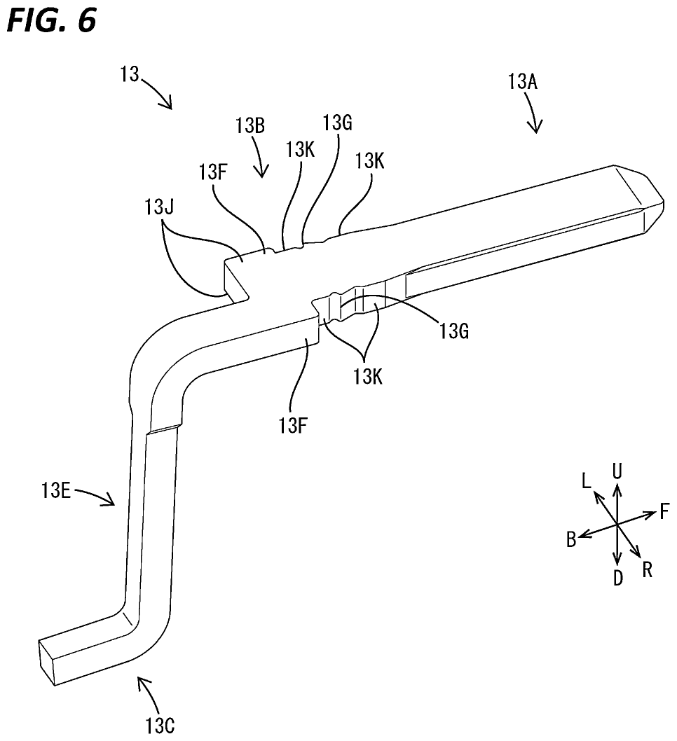

Next, the configuration of the terminal fitting 13 will be described. The terminal fittings 13 disclosed in Embodiment 1 vary in size and lengths of portions, but all of them have a configuration described below. Each of the terminal fitting 13 is formed by, for example, pressing a metal plate. The terminal fitting 13 is plated, for example, and the outer surface thereof is covered by a plating layer. As shown in FIG. 6, the terminal fitting 13 includes a partner connection portion 13A, a base portion 13B, a downward extending portion 13E, and a board connection portion 13C.

The partner connection portion 13A extends in the front-back direction. The partner connection portion 13A is electrically connected to a partner terminal fitting (not illustrated) held in a partner housing (not illustrated) when the housing 11 is fitted to the partner housing.

The base portion 13B is continuous with the back end of the partner connection portion 13A. The upper and lower surfaces of the base portion 13B correspond to the first surfaces 13J. The pair of first surfaces 13J face toward opposite sides in the vertical direction (first direction) intersecting the front-back direction. The left and right surfaces of the base portion 13B correspond to the second surfaces 13K. The pair of second surfaces 13K face toward opposite sides in the left-right direction (second direction) intersecting the front-back direction and the vertical direction.

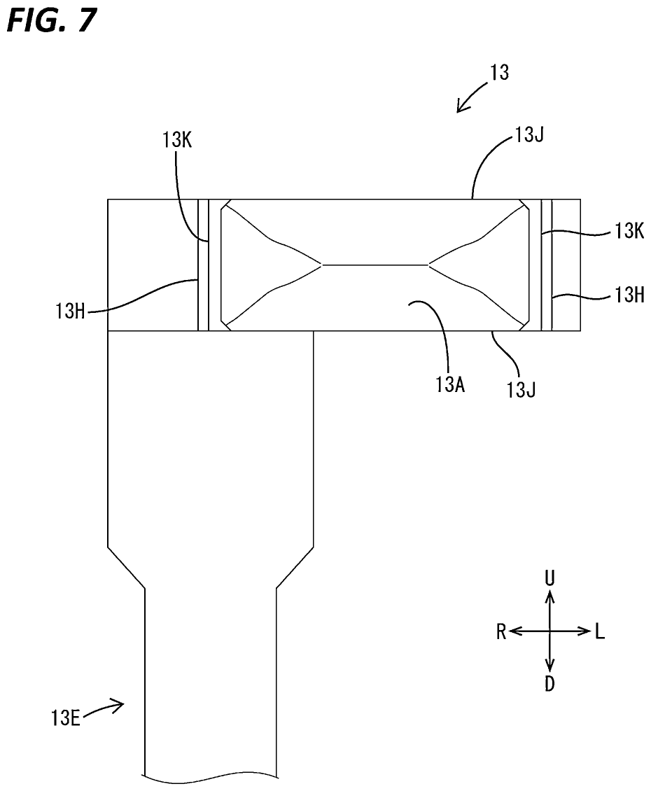

The width of each first surface 13J in the left-right direction (second direction) is larger than the dimension of each second surface 13K in the vertical direction (first direction) (see FIG. 7). The dimension between the pair of first surfaces 13J is smaller than the dimension between the parallel surfaces 11H of the pair of first opposed surfaces 11D of the press-fitting hole 11C (see FIG. 8). Specifically, the dimension between the pair of parallel surfaces 11H is nearly equal to the maximum tolerance of the dimension between the pair of first surfaces 13J. The width between the pair of second surfaces 13K is slightly larger than the width between the pair of second opposed surfaces 11E of the press-fitting hole 11C (see FIG. 9).

The base portion 13B includes a pair of stoppers 13F and a pair of locking portions 13G. The pair of stoppers 13F are located on the back portion of the base portion 13B, are continuous with the second surfaces 13K, protrude outward in the left-right direction (second direction) relative to the second surfaces 13K, and have a rectangular shape. The pair of locking portions 13G are located forward of the pair of stoppers 13F (on the front side in the press-fitting direction). The locking portions 13G are continuous with the second surfaces 13K, protrude outward in the left-right direction (second direction) relative to the second surfaces 13K, and have a bulging shape. In each of the locking portions 13G, an apex 13H that protrudes to the outermost side in the left-right direction is located at a position on the back side of the center in the front-back direction (see FIG. 9). The width between the pair of apexes 13H is larger than the width between the pair of second surfaces 13K (see FIG. 9).

The downward extending portion 13E is continuous with the back end of the base portion 13B, is bent backward and downward, and extends downward. The board connection portion 13C is continuous with the lower end of the downward extending portion 13E, is bent backward, and extends backward. The board connection portion 13C is disposed along the plate surface of the circuit board S, and is electrically connected to a conductive portion (not illustrated) of the circuit board S through soldering (see FIG. 2).

### [Example of Procedure for Attaching Terminal Fitting to Housing]

First, the terminal fitting 13 is arranged such that the partner connection portion 13A is located on the front side and the board connection portion 13C is located backward and downward of the partner connection portion 13A. Then, the partner connection portion 13A is brought close to the press-fitting hole 11C from the back side. In other words, the terminal fitting 13 is moved from the back side toward the front side in the press-fitting direction, and is brought close to the press-fitting hole 11C from the back side. At this time, for example, the back end of base portion 13B is pressed from the back side using a press-fitting jig (not illustrated).

The dimension of the partner connection portion 13A in the vertical direction is slightly smaller than the dimension between the pair of parallel surfaces 11H of the press-fitting hole 11C (see FIG. 8). Also, the dimension of the partner connection portion 13A in the left-right direction is slightly smaller than the dimension between the pair of second opposed surfaces 11E of the press-fitting hole 11C (see FIG. 9). Accordingly, the partner connection portion 13A passes forward through the press-fitting hole 11C without the generation of great friction force against the press-fitting hole 11C, and protrudes inside the hood portion 11B.

Next, the front end portion of the base portion 13B reaches the second guiding surfaces 11G. The dimension between the pair of first surfaces 13J is slightly smaller than the dimension between the parallel surfaces 11H of the pair of first opposed surfaces 11D of the press-fitting hole 11C (see FIG. 8). The width between the pair of second surfaces 13K is slightly larger than the width between the pair of second opposed surfaces 11E of the press-fitting hole 11C (see FIG. 9). Accordingly, the base portion 13B is press-fitted into the press-fitting hole 11C with the second surfaces 13K pressing the second opposed surfaces 11E outward in the left-right direction to increase the dimension between the second opposed surfaces 11E. Then, each of the locking portions 13G comes into contact with the second guiding surface 11G from the back side. In other words, each of the locking portions 13G is capable of coming into contact with the second guiding surface 11G when the terminal fitting 13 is press-fitted into the press-fitting hole 11C. Thereafter, the locking portion 13G moves forward while biting the second opposed surface 11E, and is press-fitted into the press-fitting hole 11C (see FIG. 9).

Each of the stoppers 13F is inserted into the press-fitting hole 11C from the back side in the forward direction (press-fitting direction), and reaches and comes into contact with the contact surface 11F (see FIG. 9). In this manner, the terminal fitting 13 is press-fitted into the press-fitting hole 11C from the back side in the press-fitting direction, is locked thereto due to the locking portions 13G biting the second opposed surfaces 11E of the press-fitting hole 11C of the housing 11, and is held in the housing 11. In the state in which the stoppers 13F are in contact with the contact surfaces 11F, the apexes 13H of the locking portions 13G are located forward of the inclination front end positions Sp (on the front side in the press-fitting direction) (see FIG. 9).

Even if each of the first surfaces 13J comes into contact with the first opposed surface 11D and abrasion powder is generated from the plating layer or the like that forms the first surface 13J, the abrasion powder is likely to be held between the first surface 13J and the first guiding surface 11J and is unlikely to be released to the outside. Also, even if abrasion powder is generated from the plating layers or the like that form the second surfaces 13K and the outer surfaces of the locking portions 13G due to the second opposed surfaces 11E, the abrasion powder is trapped inside a region surrounded by the second surface 13K, the second guiding surface 11G, and the stopper 13F (see FIG. 9), and is unlikely to be released to the outside.

The following describes the functions of Embodiment 1.

The connector 10 includes the housing 11 provided with the press-fitting hole 11C, and the terminal fitting 13 that is press-fitted into the press-fitting hole 11C from the back side in the front-back direction (press-fitting direction) and is held in the housing 11. The terminal fitting 13 includes the pair of first surfaces 13J, the pair of second surfaces 13K, and the pair of stoppers 13F. The pair of first surfaces 13J face toward opposite sides in the vertical direction (first direction) intersecting the front-back direction (press-fitting direction). The pair of second surfaces 13K face toward opposite sides in the left-right direction (second direction) intersecting the front-back direction (press-fitting direction) and the vertical direction (first direction). The pair of stoppers 13F protrude in the left-right direction (second direction) relative to the second surfaces 13K. The press-fitting hole 11C includes the pair of first opposed surfaces 11D that are opposed to the first surfaces 13J, the pair of second opposed surfaces 11E that are opposed to the second surfaces 13K, and the contact surfaces 11F with which the stoppers 13F are capable of coming into contact in the forward direction (press-fitting direction). The first opposed surfaces 11D each include the first guiding surface 11J, the pair of first guiding surfaces 11J are inclined to increase the distance therebetween from the inclination front end positions Sp to the inclination back end positions Ep, and the inclination front end positions Sp are located forward of the contact surfaces 11F in the press-fitting direction.

With this configuration, the inclination front end positions Sp are located forward of the contact surfaces 11F in the press-fitting direction. This enables a reduction of the area of contact between the first surface 13J and the parallel surface 11H of the first opposed surface 11D, thus making it less likely that the first surfaces 13J of the terminal fitting 13 are abraded by the first opposed surfaces 11D. In addition, when the terminal fitting 13 is press-fitted into the press-fitting hole 11C, abrasion powder resulting from the abrasion of the plating layer or the like that forms the first surface 13J by the first opposed surface 11D is likely to be held between the first guiding surface 11J and the first surface 13J. This makes it likely to prevent trouble caused by the abrasion powder from the terminal fitting 13.

The terminal fitting 13 includes the pair of locking portions 13G that protrude outward in the left-right direction (second direction) relative to the second surfaces 13K and are located forward of the stoppers 13F in the front-back direction (press-fitting direction). In the state in which the stoppers 13F are in contact with the contact surfaces 11F, the apexes 13H of the locking portions 13G are located forward of the inclination front end positions Sp in the front-back direction (press-fitting direction). With this configuration, the locking portions 13G are press-fitted into the press-fitting hole 11C after the positions of the locking portions 13G in the vertical direction are determined, thus making it easy to suppress the positional shift of the locking portions 13G in the vertical direction (first direction).

The housing 11 includes the press-fitting surface 11K in which the press-fitting hole 11C is open, the contact surfaces 11F are located forward of the press-fitting surface 11K in the front-back direction (press-fitting direction), and the first guiding surfaces 11J intersect and are continuous with the press-fitting surface 11K. With this configuration, the function of the first guiding surfaces 11J to guide the terminal fitting 13 to the press-fitting hole 11C is exhibited over a broad range in the front-back direction. In addition, for example, it is easy to secure the clearance between a jig for pressing the terminal fitting 13 and the opening of the press-fitting hole 11C.

The second guiding surfaces 11G are each formed between the second opposed surface 11E and the contact surface 11F, the second guiding surfaces 11G forming a tapered shape and being capable of coming into contact with the locking portions 13G when the terminal fitting 13 is press-fitted into the press-fitting hole 11C. With this configuration, the second guiding surfaces 11G can guide the locking portions 13G, thus making it easy to press-fit the terminal fitting 13 into the press-fitting hole 11C.

The dimension between the pair of first surfaces 13J is smaller than the dimension between the parallel surfaces 11H of the pair of first opposed surfaces 11D. With this configuration, when the terminal fitting 13 is press-fitted into the press-fitting hole 11C, it is possible to make it unlikely that the first surfaces 13J come into contact with the first opposed surfaces 11D, thus making it less likely that the terminal fitting 13 is abraded.

The dimensions of the first surfaces 13J in the left-right direction (second direction) are larger than the dimensions of the second surfaces 13K in the vertical direction (first direction). With this configuration, the dimensions of the first opposed surfaces 11D (first guiding surfaces 11J) in the left-right direction (second direction) are increased, thus making it likely to reduce the contact pressure per unit area when the first guiding surfaces 11J and the first surfaces 13J come into contact with each other and to improve the effect of preventing the abrasion of the first surfaces 13J.

### Other Embodiments

The embodiments disclosed herein are exemplary in all respects, and should be construed as being not limitative. The scope of the present invention is not limited to the embodiments disclosed herein and is defined by the scope of the appended claims, and all changes that fall within the same essential spirit as the scope of the claims are intended to be included therein.

Unlike Embodiment 1, the press-fitting direction, the first direction, and the second direction need not be orthogonal to one another, and a configuration may be employed in which they merely intersect one another.

Unlike Embodiment 1, the inclination back end positions may be located forward of the press-fitting surface and backward of the contact surfaces. In this case, the inclination back end positions may be coupled to the press-fitting surface via plane surfaces parallel to the parallel surfaces or via plane surfaces inclined at angles different from the inclination angles of the first guiding surfaces.

Unlike Embodiment 1, each of the first guiding surfaces may be curved between the inclination front end position and the inclination back end position.

Unlike Embodiment 1, the configuration and the technology of the present disclosure may be applied to only some of a plurality of press-fitting holes formed in the housing.

A connector that includes a housing made of a synthetic resin to which glass fibers are not added unlike Embodiment 1 is also within the scope of application of the technology of the present disclosure.

Unlike Embodiment 1, the apexes of the locking portions and the inclination front end positions may be located at the same position in the front-back direction (press-fitting direction) in the state in which the stoppers are in contact with the contact surfaces.

Unlike Embodiment 1, a configuration may be employed in which the terminal fitting is press-fitted from the front side of the press-fitting wall portion. In this case, the backward direction corresponds to the press-fitting direction. Before press-fitted into the press-fitting wall portion, the terminal fitting is arranged such that the partner connection portion, the base portion, the downward extending portion, and the board connection portion are lined up in this order, and the board connection portion, the downward extending portion, and the base portion are press-fitted into the press-fitting hole in this order. Then, after the board connection portion and the downward extending portion protrude backward from the press-fitting wall portion, the downward extending portion is bent.

Unlike embodiment 1, the first direction may correspond to the left-right direction, and the second direction may correspond to the vertical direction. In addition, the direction in which the press-fitting hole passes through the press-fitting wall portion is not limited to the front-back direction. That is to say, the press-fitting direction need only correspond to the direction in which the press-fitting hole passes through the press-fitting wall portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing provided with a press-fitting hole; and
a terminal fitting that is press-fitted into the press-fitting hole from a back side in a press-fitting direction and is held in the housing,
wherein the terminal fitting includes a pair of first surfaces that face toward opposite sides in a first direction intersecting the press-fitting direction, a pair of second surfaces that face toward opposite sides in a second direction intersecting the press-fitting direction and the first direction, and a pair of stoppers that protrude in the left-right direction (second direction) relative to the second surfaces,
the press-fitting hole includes a pair of first opposed surfaces that are opposed to the first surfaces, a pair of second opposed surfaces that are opposed to the second surfaces, and contact surfaces with which the stoppers are capable of coming into contact in the press-fitting direction,
the pair of first opposed surfaces each include a first guiding surface, the pair of first guiding surfaces being inclined to increase a distance therebetween from inclination front end positions to inclination back end positions, and
the inclination front end positions are located forward of the contact surfaces in the press-fitting direction.

2. The connector according to claim 1,
wherein the terminal fitting includes a pair of locking portions that protrude in the second direction relative to the second surfaces and are located forward of the stoppers in the press-fitting direction, and
in a state in which the stoppers are in contact with the contact surfaces, apexes of the locking portions are located at the same position as those of the inclination front end positions in the press-fitting direction or are located forward of the inclination front end positions in the press-fitting direction.

3. The connector according to claim 1,
wherein the housing includes a press-fitting surface in which the press-fitting hole is open, the contact surfaces being located forward of the press-fitting surface in the press-fitting direction, and
the first guiding surfaces intersect and are continuous with the press-fitting surface.

4. The connector according to claim 2,
wherein second guiding surfaces are each formed between the second opposed surface and the contact surface, the second guiding surfaces forming a tapered shape and being capable of coming into contact with the locking portions when the terminal fitting is press-fitted into the press-fitting hole.

5. The connector according to claim 1,
a dimension between the pair of first surfaces is smaller than a dimension between the pair of first opposed surfaces.

6. The connector according to claim 5,
wherein dimensions of the first surfaces in the second direction are larger than dimensions of the second surfaces in the first direction.
